(19) United States
(12) Patent Application Publication
(10) Pub. No.: US 2015/0223627 A1
(43) Pub. Date: Aug. 13, 2015

(54) PRESSURE COOKER

(71) Applicant: TOP ELECTRIC APPLIANCE INDUSTRIAL LTD., Guangzhou, Guangdong (CN)

(72) Inventors: Weizhong Li, Guangzhou (CN); Yewu Zhong, Guangzhou (CN)

(21) Appl. No.: 14/424,101

(22) PCT Filed: Feb. 7, 2014
(86) PCT No.: PCT/CN2014/071887

§ 371 Date: Feb. 26, 2015

(30) Foreign Application Priority Data
Jul. 17, 2013 (CN) 201320424308.X
Aug. 13, 2013 (CN) 201310350870.7
Aug. 13, 2013 (CN) 201320492228.8

(51) Int. Cl. A47J 27/08; A47J 27/04; A47J 27/09

(52) U.S. Cl. CPC A47J 27/0802; A47J 27/09; A47J 27/04

(57) ABSTRACT

A pressure cooker (1) comprises: a pressure vessel (2) for containing items to be cooked; an inlet (3) in a wall of the pressure vessel (2) for receiving steam from a steam source; and a pump (4) for pumping the steam from the steam source into the pressure vessel (2) through the inlet (3), wherein the pump (4) produces a maximum pressure below a maximum safety pressure for the pressure vessel (2).

### TECHNICAL FIELD

The present invention relates to pressure cookers, and in particular, pressure cookers for cooking food. The present invention is described herein primarily in relation to pressure cookers used in domestic kitchens, but is not limited to this particular application.

### BACKGROUND ART

Pressure cookers typically comprise pressure vessels for containing items to be cooked. Prior methods of generating pressure in pressure cookers involved sealing the pressure vessel and heating the contents of the pressure vessel. Typical heat sources for heating the contents included placing the pressure vessel onto a stove. Other pressure cookers had heating elements that were electrically powered to heat the pressure vessel. The heating resulted in a continuous increase in pressure and temperature inside the pressure vessel. The increase in pressure was typically controlled by having a pressure relief valve on the pressure cooker that exhausted content, such as steam, from the pressure cooker to relieve pressure inside the pressure vessel so as to maintain the pressure inside the pressure vessel below a maximum pressure. Temperature was not separately controlled.

These prior pressure cookers posed safety problems since any blockage of the relief valve would allow the pressure to increase continuously if the heat source was not removed. This can result in failure of the pressure cooker including catastrophic failure such as explosive rupturing of the pressure vessel, which could cause serious injuries to persons nearby. As a result, these types of pressure cookers typically include separate safety valves. However, the same problem can still occur since these separate safety valves could also be blocked.

Furthermore, since pressure cookers are used to cook food items, food tends to accumulate in the valves, which exacerbates the problem of valve blockage described above. Therefore, users of pressure cookers must be diligent in cleaning the valves.

Since temperature was not separately controlled, it was difficult to maintain the correct temperature for cooking different food items. Temperature simply increased with the increase in pressure, and there was no control over the temperature at a given pressure. This often resulted in less than optimal cooking of food items, and sometimes resulted in the burning of food, especially adjacent the portion of the pressure vessel closes to the heat source, such as the bottom of the pressure vessel in the case where these are placed on stoves.

Some pressure cookers had valves that were manually adjustable to different maximum pressures. However, it was still difficult to set the pressure cooker at the right pressure for different food items, especially when seals wore over time or were not seated properly. Even if it was possible to do so, it would still not overcome the problems of lack of temperature control and valve blockage.

Furthermore, the heat methods described above often result in uneven heating. Heating on stoves has the additional safety problems of an exposed heat source, such as naked flames. Stove heating is also inefficient since heat dissipation is large.

It is an object of the present invention to overcome or ameliorate at least one of the disadvantages of the prior art, or to provide a useful alternative.

### DISCLOSURE OF INVENTION

### Solution to Problem

### Technical Solution

The present invention provides a pressure cooker comprising:

a pressure vessel for containing items to be cooked;

an inlet in a wall of the pressure vessel for receiving steam from a steam source; and

a pump for pumping the steam from the steam source into the pressure vessel through the inlet, wherein the pump produces a maximum pressure below a maximum safety pressure for the pressure vessel.

Further features of the present invention are defined in the appended claims. It will be appreciated that these features may be combined in various combinations in various embodiments of the present invention.

Throughout this specification, including the claims, the words “comprise”, “comprising”, and other like terms are to be construed in an inclusive sense, that is, in the sense of “including, but not limited to”, and not in an exclusive or exhaustive sense, unless explicitly stated otherwise or the context clearly requires otherwise.

### BRIEF DESCRIPTION OF DRAWINGS

### Description of Drawings

Preferred embodiments in accordance with the best mode of the present invention will now be described, by way of example only, with reference to the accompanying figures, in which:

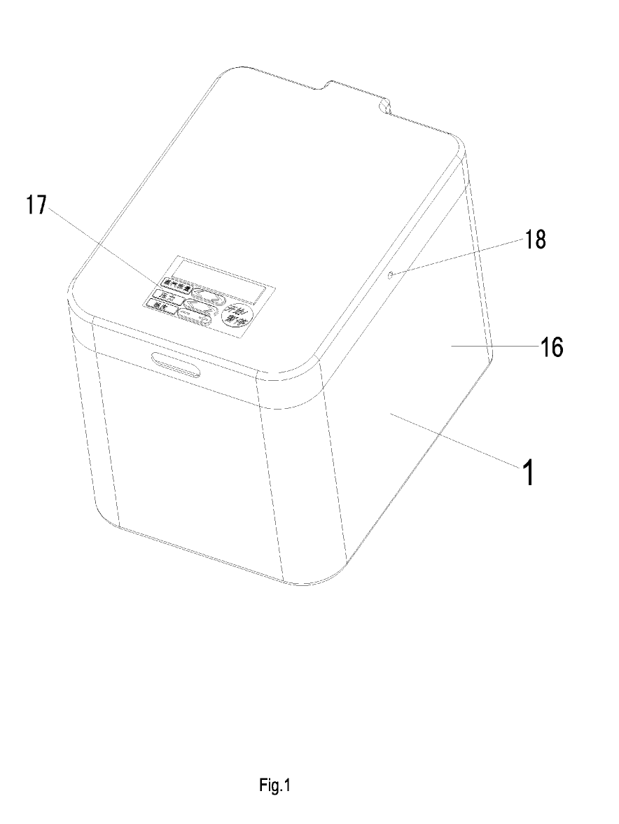

FIG. 1 is a perspective view of a pressure cooker in accordance with one embodiment of the present invention;

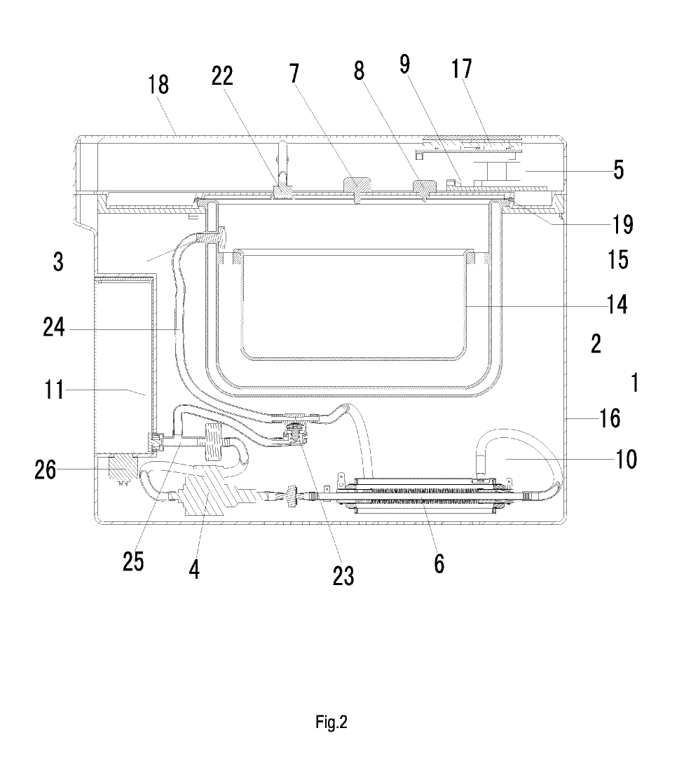

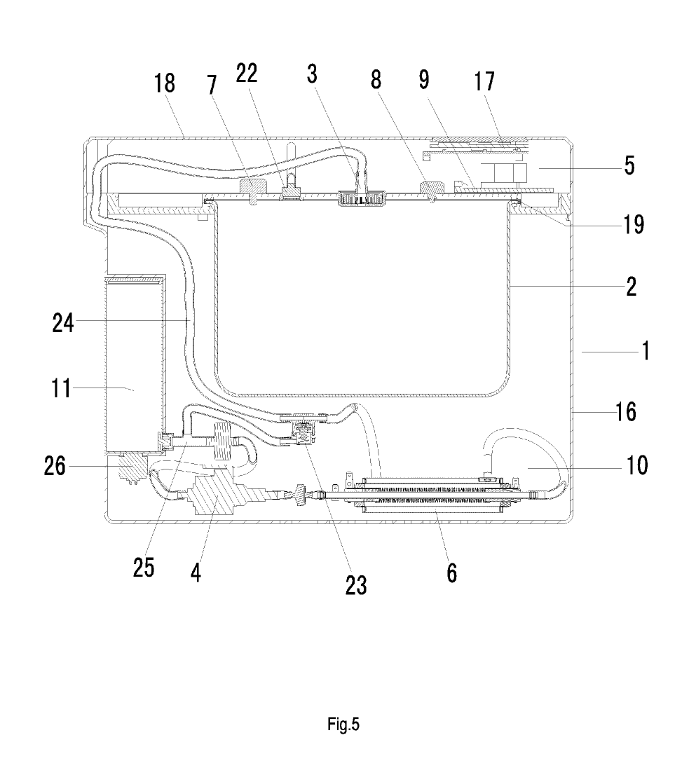

FIGS. 2 to 5 are cutaway side views of pressure cookers in accordance with various respective embodiments of the present invention;

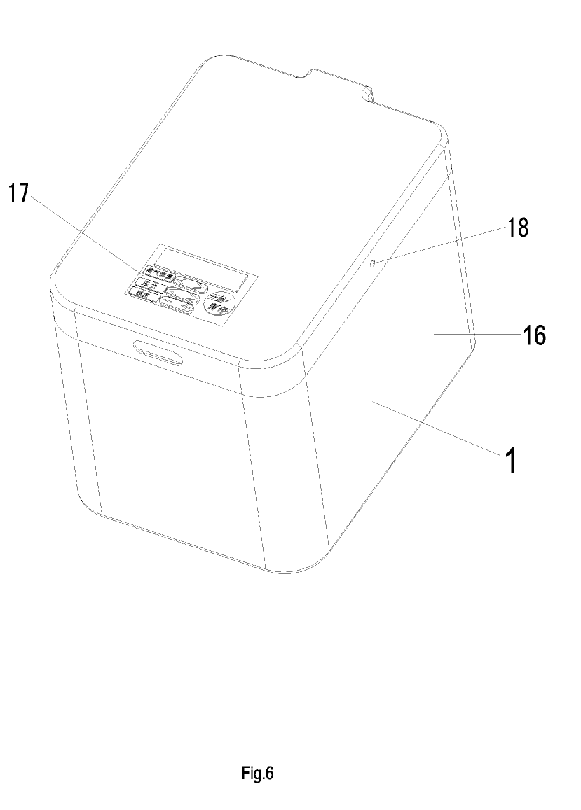

FIG. 6 is a perspective view of a pressure cooker in accordance with another embodiment of the present invention;

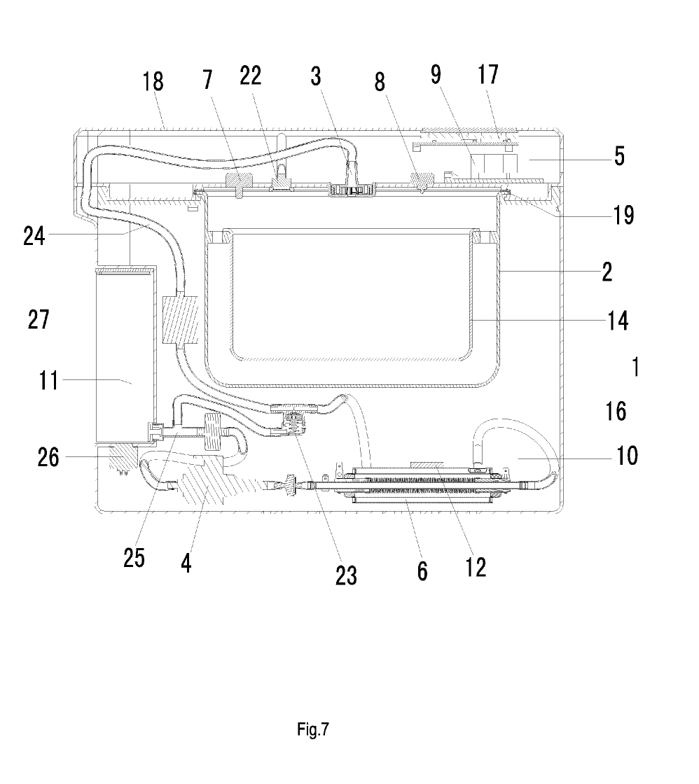

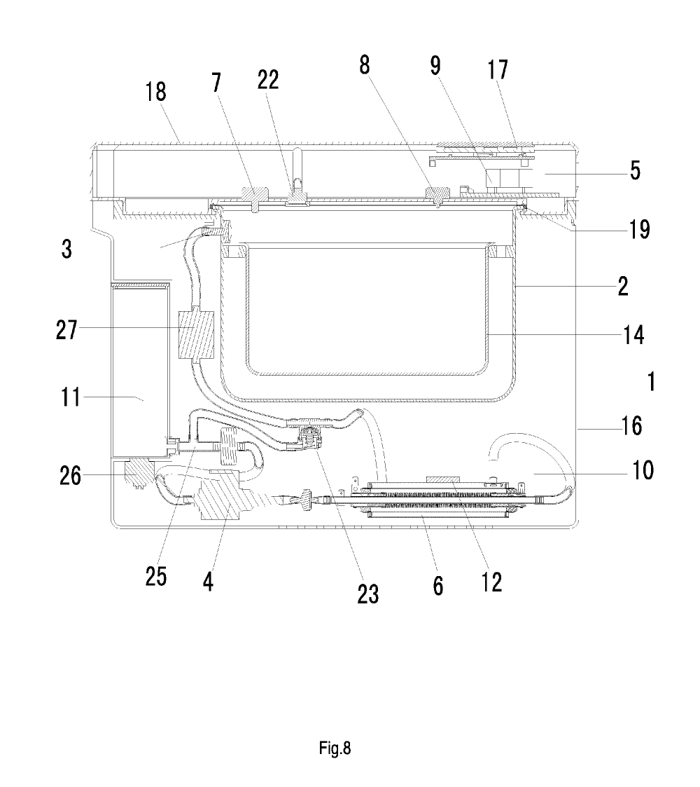

FIGS. 7 and 8 are cutaway side views of pressure cookers in accordance with two respective embodiments of the present invention;

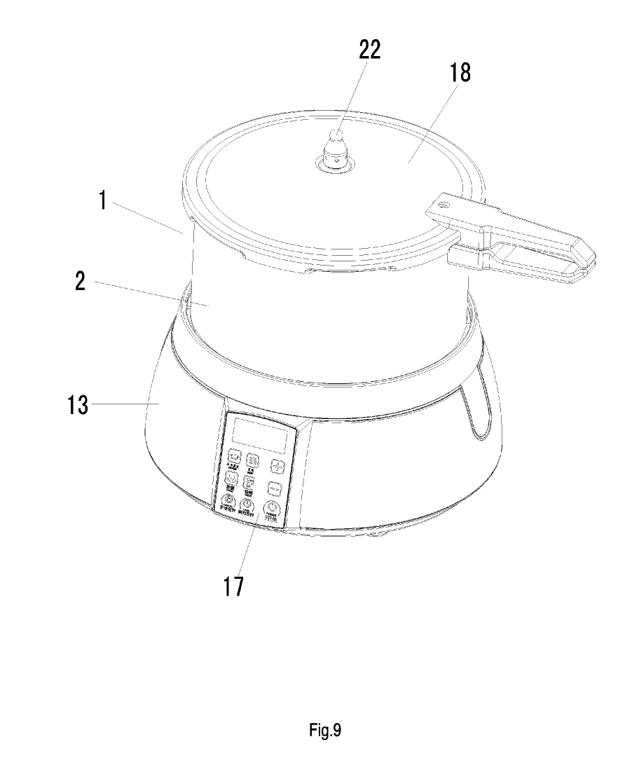

FIG. 9 is a perspective view of a pressure cooker in accordance with a further embodiment of the present invention;

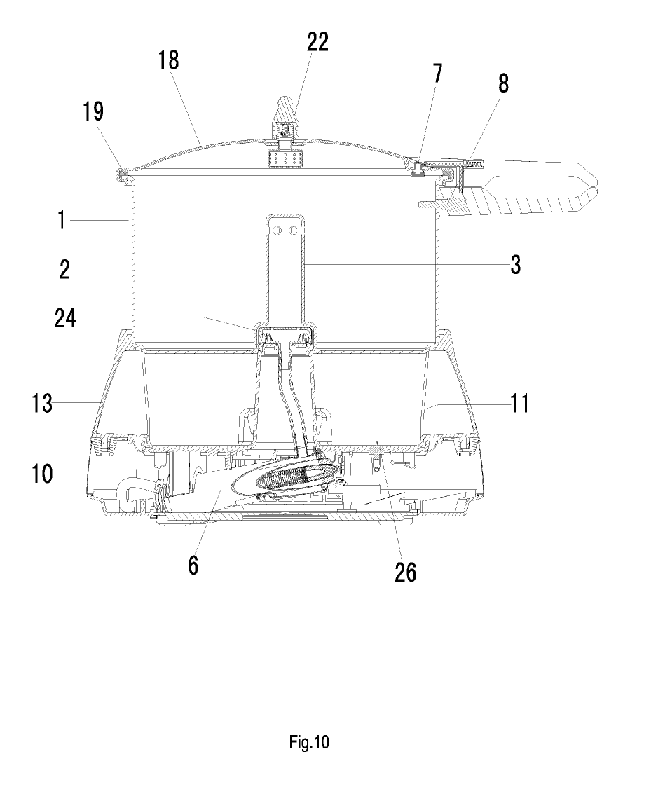

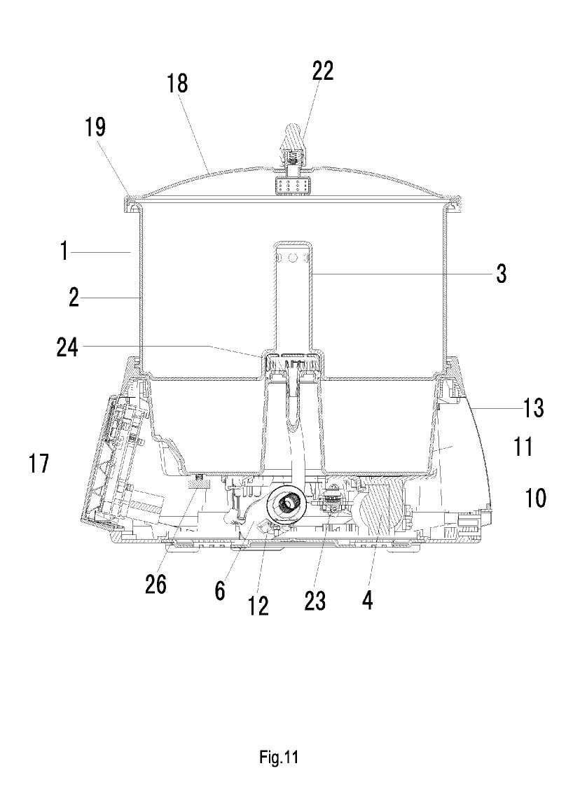

FIGS. 10 and 11 are cutaway side views of a pressure cooker in accordance with another embodiment of the present invention; and

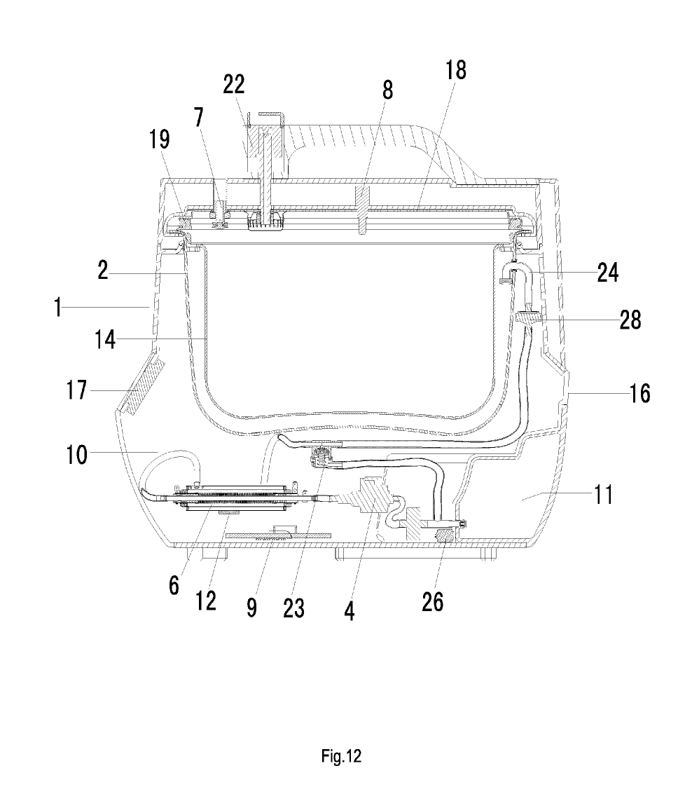

FIG. 12 is a cutaway side view of a pressure cooker in accordance with a further embodiment of the present invention.

### BEST MODE FOR CARRYING OUT THE INVENTION

### Best Mode

Referring to the figures, embodiments of the present invention provide a pressure cooker 1 comprising a pressure vessel 2 for containing items to be cooked. There is an inlet 3 in a wall of the pressure vessel for receiving steam from a steam source. The pressure cooker 1 further comprises a pump 4 for pumping the steam from the steam source into the pressure vessel through the inlet, wherein the pump produces a maximum pressure below a maximum safety pressure for the pressure vessel.

It is preferable that the maximum safety pressure is below the pressure causing failure of the pressure cooker. Failure of the pressure cooker includes rupturing of the pressure vessel 2, bursting of a line or pipe that carries steam to the pressure vessel, and any other failure that renders the pressure cooker unusable. However, ‘failure’ can also refer to the pump shutting down and allowing pressure to relieve fully to ambient pressure, and not necessarily sustaining any damage that requires repair. In some embodiments, the maximum pressure is from 1.5 bar to 4.0 bar. This is the maximum pressure rating of many pumps that are suitable for pressure cookers according to the present invention.

Thus, in pressure cookers according to the present invention, the pressure inside the pressure vessel 2 should never rise above the maximum pressure of the pump 4 through operation of the pump. If the pressure inside the pressure vessel 2 were to rise above the maximum pressure of the pump 4 for some reason, the pump 4 would fail, and therefore, the pressure inside the pressure vessel would drop to ambient pressure. Since the maximum pressure of the pump 4 is below the maximum safety pressure for the pressure vessel 2, the pressure inside the pressure vessel will never reach the maximum safety pressure.

The pressure cooker 1 comprises a control apparatus 5 to maintain the pressure inside the pressure vessel 2 at a selected pressure selectable by a user. The control apparatus 5 regulates the operation of the pump 4 to maintain the pressure inside the pressure vessel at the selected pressure. In one preferred embodiment, the control apparatus 5 switches the pump 4 off when the pressure inside the pressure vessel 2 is above the selected pressure and switches the pump 4 on when the pressure inside the pressure vessel 2 is below the selected pressure, thereby to maintain the pressure inside the pressure vessel at the selected pressure.

Throughout the present specification, any reference to the pump 4 being switched ‘off’ includes switching the pump to a standby state, or any other condition where the pump stops generating pressure but maintains or relieves pressure.

In some embodiments, the control apparatus 5 regulates the temperature of the steam to maintain the pressure inside the pressure vessel 2 at the selected pressure. In embodiments where the steam source comprises heating apparatus 6 to heat the steam, the control apparatus 5 switches the heating apparatus 6 off when the pressure inside the pressure vessel 2 is above the selected pressure and switches the heating apparatus 6 on when the pressure inside the pressure vessel 2 is below the selected pressure, thereby to maintain the pressure inside the pressure vessel at the selected pressure.

In some embodiments, the control apparatus 5 regulates both the operation of the pump 4 and the temperature of the steam to maintain the pressure inside the pressure vessel 2. For example, the control apparatus 5 regulates both the operation of the pump 4 and the temperature of the steam as respectively described above. The control apparatus decides how the operation of the pump 4 and the temperature of the steam are regulated relative to each other. Depending on the circumstances and requirements, the control apparatus 5 can regulate only the operation of the pump 4, or regulate only the temperature of the steam, or regulate both the operation of the pump 4 and the temperature of the steam in a certain proportion to each other.

The pressure cooker 1 comprises a pressure sensor 7 to measure the pressure inside the pressure vessel 2. The pressure sensor 7 provides a pressure signal based on the measured pressure to the control apparatus 5. The control apparatus 5 uses the pressure signal to maintain the pressure inside the pressure vessel 2 at the selected pressure by, for example, regulating the operation of the pump 4 or regulating the temperature of the steam, based on the pressure signal.

In some embodiments, the control apparatus 5 maintains the temperature inside the pressure vessel 2 at a selected temperature selectable by a user. The control apparatus 5 regulates the operation of the pump 4 to maintain the temperature inside the pressure vessel 2 at the selected temperature. In one preferred embodiment, the control apparatus 5 switches the pump 4 off when the temperature inside the pressure vessel 2 is above the selected temperature and switches the pump 4 on when the temperature inside the pressure vessel 2 is below the selected temperature, thereby to maintain the temperature inside the pressure vessel at the selected temperature.

In some embodiments, the control apparatus 5 regulates the temperature of the steam to maintain the temperature inside the pressure vessel 2 at the selected temperature. In embodiments where the steam source comprises heating apparatus 6 to heat the steam, the control apparatus 5 switches the heating apparatus 6 off when the temperature inside the pressure vessel 2 is above the selected temperature and switches the heating apparatus 6 on when the temperature inside the pressure vessel 2 is below the selected temperature, thereby to maintain the temperature inside the pressure vessel at the selected temperature.

In some embodiments, the control apparatus 5 regulates both the operation of the pump 4 and the temperature of the steam to maintain the temperature inside the pressure vessel 2. For example, the control apparatus 5 regulates both the operation of the pump 4 and the temperature of the steam as respectively described above. The control apparatus decides how the operation of the pump 4 and the temperature of the steam are regulated relative to each other. Depending on the circumstances and requirements, the control apparatus 5 can regulate only the operation of the pump 4, or regulate only the temperature of the steam, or regulate both the operation of the pump 4 and the temperature of the steam in a certain proportion to each other.

The pressure cooker 1 comprises a temperature sensor 8 to measure the temperature inside the pressure vessel 2. The temperature sensor 8 provides a temperature signal based on the measured temperature to the control apparatus 5. The control apparatus 5 uses the temperature signal to maintain the temperature inside the pressure vessel 2 at the selected temperature by, for example, regulating the operation of the pump 4 or regulating the temperature of the steam, based on the temperature signal.

In some embodiments, the control apparatus 5 maintains the pressure inside the pressure vessel 2 at a selected pressure selectable by a user, and simultaneously maintains the temperature inside the pressure vessel 2 at a selected temperature selectable by a user. The control apparatus can do this by regulating only the operation of the pump 4, or regulating only the temperature of the steam, or regulating both the operation of the pump 4 and the temperature of the steam in a certain proportion to each other.

The control apparatus 5 can comprise a control circuit 9 to automatically maintain the pressure and/or temperature inside the pressure vessel 2 at the selected pressure and/or selected temperature. Although it is appreciated that the control apparatus can include manual controls both exclusively or in combination with automatic controls.

The steam source is a steam generator 10 forming part of the pressure cooker 1. The steam generator can include heating apparatus 6 to adjust the temperature of the steam. Examples of suitable steam generators are the devices for heating and/or vaporizing a fluid disclosed in PCT application number PCT/CN2013/081657 previously filed by the present applicant. One such device comprises: a heat conductive inner conduit having an interior surface defining a fluid flow pathway therethrough and an outlet for emitting heated fluid or vapour from the fluid flow pathway; an electrically powered heating element arranged near to an exterior surface of said inner conduit whereby heat energy from the heating element is received at the exterior surface of the inner conduit and conducted by the inner conduit to its interior surface to heat fluid passing through the fluid flow pathway; and a casing sealably surrounding the heating element, said casing having an exterior surface in communication with a space into which heated fluid or vapour is emitted from the outlet of the inner conduit, said casing being heat conductive such that heat energy received from the heating element is conducted by the casing to its exterior surface to heat fluid within said space. Another such device comprises: an electrically powered heating element arranged around an inner conduit defining a first fluid flow pathway to heat fluid flowing through said first fluid flow pathway; and a housing surrounding the heating element and inner conduit and defining a second fluid flow pathway arranged to be heated by the heating element, an inlet of the second fluid flow pathway being connected to an outlet of the first fluid flow pathway whereby heated fluid or vapour emitted from the first fluid flow pathway is further heated in the second fluid flow pathway.

The pressure cooker 1 comprises a water tank 11 for supplying water to the steam generator 10. The pump 4 is between the water tank 11 and the steam generator 10 and pumps water from the water tank to the steam generator and continues to pump steam generated from the steam generator into the pressure vessel 2 through the inlet 3.

For added safety, where the steam generator 10 is powered by an electrical supply, the pressure cooker 1 comprises a safety fuse 12. The safety fuse 12 disconnects the steam generator 10 from the electrical supply when the steam reaches a maximum safety temperature.

The pressure cooker 1 comprises a base, wherein the steam generator is located in the base and the pressure vessel 2 is located on top of the base. The pump 4 is also located in the base. All or some of the other components can also be located in the base in accordance with particular design requirements. The base can be integrated with the rest of the pressure cooker 1, or it can form a separable component from the rest of the pressure cooker 1. The latter arrangement allows, for example, the pressure vessel 2 to be separated from the base to facilitate easy cleaning. FIGS. 9 to 11 depict embodiments of this type with the base indicated as feature 13.

In some embodiments, the pressure vessel 2 is configured to receive a separate inner food container 14, which can be removed and replaced. FIGS. 2, 3, 7, 8, and 12 depict embodiments of this type. In these embodiments, the inner food container 14 is supported inside the pressure vessel 2 by support structures 15. The pressure cooker 1 preferably has an outer housing 16 to house all the components.

A control panel 17 is located on the outer housing to allow a user to control and program functions of the pressure cooker 1. The control panel can have a user interface in the form of, for example, buttons or a touch screen, to allow the user to select the pressure and/or temperature for cooking. The control panel can also allow the user to select cooking programs in which the pressure and/or temperature varies over time with the control apparatus 5 automatically adjusting and maintaining the pressure and/ or temperature accordingly. The control panel can also allow the user to set other functions such as a cooking timer in accordance with known methods. Furthermore, the control panel can include a display to display data such as current pressure, current temperature, cooking time, remaining cooking time, and other data as required.

The pressure vessel has a resealable lid 18. The lid includes one or more seals 19 so that it seals the pressure vessel 2 once it is closed to allow pressure to build up.

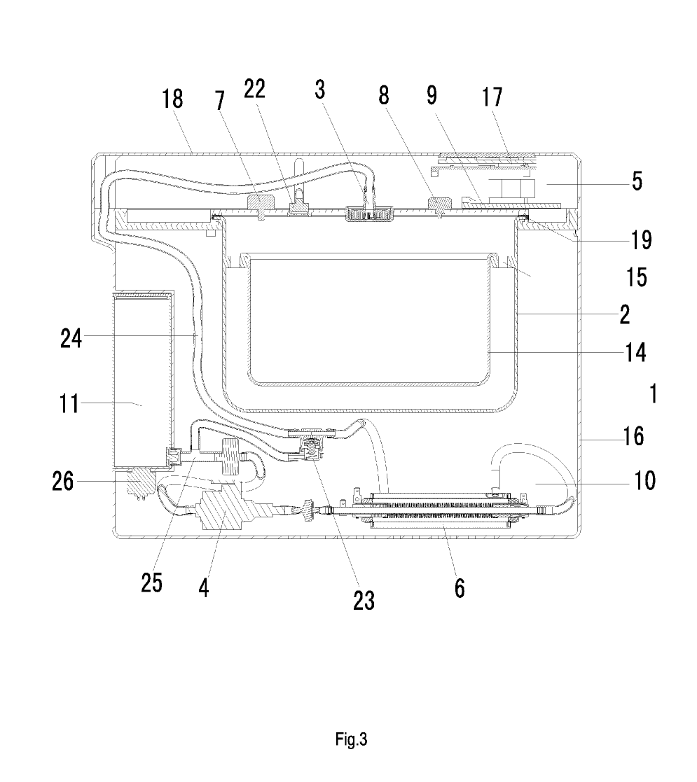

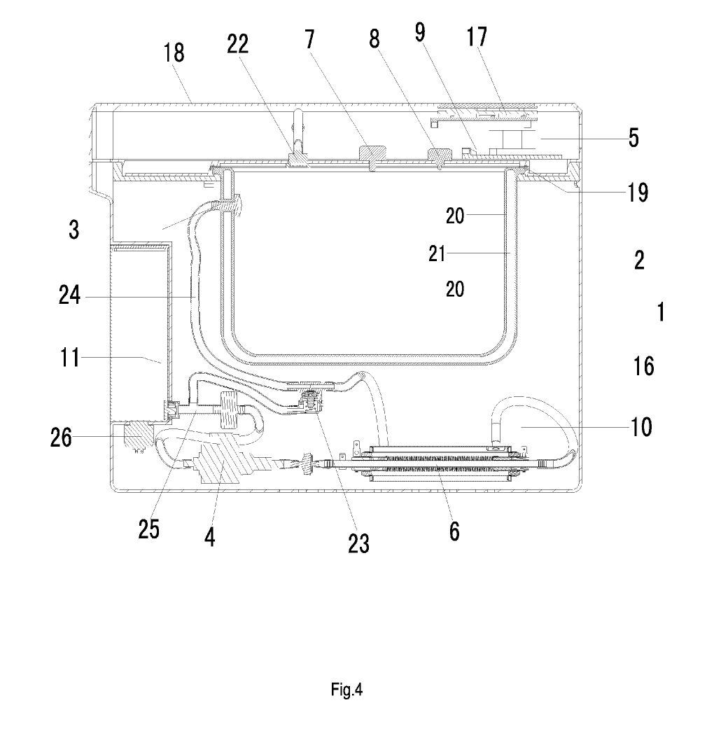

The inlet 3 can be located in the resealable lid, as shown in FIGS. 3,5, and 7. Alternatively, the inlet 3 can be located in a side wall, as shown in FIGS. 2, 4,, and 12, or a bottom wall, as shown in FIGS. 10 and 11, of the pressure vessel 2. Where the inlet 3 is located in a bottom wall, the inlet 3 can extend into the pressure vessel in the form of a conduit. The embodiments shown in FIGS. 10 and 11 show such a conduit, and in particular, a vertical conduit of circular cross-section that extends almost to the top of the pressure vessel 2. The conduit has a plurality of apertures spaced around the circumference of a top portion of the conduit. The steam is delivered into the pressure vessel 2 through the apertures by the pump 4.

In some embodiments, the pressure vessel 2 is also a vacuum vessel, wherein one or more of the walls of the pressure vessel are two-layered walls 20 with a vacuum cavity 21 between the two layers to insulate contents of the pressure vessel, as shown in FIG. 4.

For additional safety, the pressure cooker 1 comprises one or more safety relief valves 22 to exhaust content from the pressure vessel 2 to relieve pressure inside the pressure vessel when the pressure inside the pressure vessel reaches the maximum safety pressure. The pressure cooker 1 can also comprise a pumping line safety valve 23 to exhaust content from a pumping line 24 of the pump 4 to a suction line 25 of the pump to relieve pressure in the pumping line when the pressure inside the pumping line reaches a maximum pumping line safety pressure.

The pressure cooker 1 can also include a level indicator 26 to measure a level of the water tank 11. The level indicator 26 provides a level signal to the control apparatus 5, which for example, can indicate on the control panel that the water level in the water tank 11 is low and/or empty, and/or shut down the pump 4 when the water level in the water tank 11 reaches a predetermined level. The pressure cooker 1 can also include one or more flow controllers 27 to regulate the flow of the steam and/or water. The pressure cooker 1 can also include one or more check valves 28 to prevent or minimize any backflow in fluid flow lines such as the pumping line 24.

It can be appreciated that the aforesaid embodiments are only exemplary embodiments adopted to describe the principles of the present invention, and the present invention is not merely limited thereto. Various variants and modifications may be made by those of ordinary skill in the art without departing from the spirit and essence of the present invention, and these variants and modifications are also covered within the scope of the present invention. Accordingly, although the invention has been described with reference to specific examples, it can be appreciated by those skilled in the art that the invention can be embodied in many other forms. It can also be appreciated by those skilled in the art that the features of the various examples described can be combined in other combinations.

1-28. (canceled)

29. A pressure cooker comprising:
a pressure vessel for containing items to foe cooked;
an inlet, in a wall of the pressure vessel for receiving steam from a steam source; and
a pump for pumping the steam from the steam source into the pressure vessel through the inlet, wherein the pump produces a maximum pressure below a maximum safety pressure for the pressure vessel.

30. A pressure cooker according to claim 29 wherein the maximum pressure is from 1.5 bar to 4.0 bar.

31. A pressure cooker according to claim 29 comprising a control apparatus to maintain, the pressure inside the pressure vessel at a selected pressure selectable by a user.

32. A pressure cooker according to claim 31 wherein the control apparatus regulates the operation of the pump to maintain the pressure inside the pressure vessel at the selected pressure.

33. A pressure cooker according to claim 31 wherein the control apparatus regulates the temperature of the steam to maintain the pressure inside the pressure vessel at the selected pressure.

34. A pressure cooker according to claim 33 wherein the steam source comprises heating apparatus to heat the steam, and the control apparatus switches the heating apparatus off when the pressure inside the pressure vessel is above the selected pressure and switches the heating apparatus on when the pressure inside the pressure vessel is below the selected pressure, thereby to maintain the pressure inside the pressure vessel at the selected pressure.

35. A pressure cooker according to claim 31 comprising a pressure sensor to measure the pressure inside the pressure vessel, the pressure sensor providing a pressure signal based on the measured pressure to the control apparatus.

36. A pressure cooker according to claim 29 comprising a control apparatus to maintain the temperature inside the pressure vessel at a selected temperature selectable by a user.

37. A pressure cooker according to claim 36 wherein the control apparatus regulates the operation of the pump to maintain the temperature inside the pressure vessel at the selected temperature.

38. A pressure cooker according to claim 36 wherein the control apparatus regulates the temperature of the steam to maintain the temperature inside the pressure vessel at the selected temperature.

39. A pressure cooker according to claim 38 wherein the steam source comprises heating apparatus to heat the steam, and the control apparatus switches the heating apparatus off when the temperature inside the pressure vessel is above the selected temperature and switches the heating apparatus on when the temperature inside the pressure vessel is below the selected temperature, thereby to maintain the temperature inside the pressure vessel at the selected temperature.

40. A pressure cooker according to claim 31 wherein the control apparatus comprises a control circuit to automatically maintain the pressure and/or temperature inside the pressure vessel at the selected pressure and/or selected temperature.

41. A pressure cooker according to claim 29 wherein the steam source is a steam generator forming part of the pressure cooker.

42. A pressure cooker according to claim 40 wherein the pump is between a water tank and the steam generator and pumps water from the water tank to the steam generator and continues to pump steam generated from the steam generator into the pressure vessel through the inlet.

43. A pressure cooker according to claim 40 comprising a base, wherein the steam generator is located in the base and the pressure vessel is located on top of the base.

44. A pressure cooker according to claim 29 comprising a base, wherein the pump is located in the base and the pressure vessel is located on top of the base.

45. A pressure cooker according to claim 29 wherein the pressure vessel has a resealable lid.

46. A pressure cooker according to claim 45 wherein the inlet is located in the resealable lid or a side wall or a bottom wail of the pressure vessel.

47. A pressure cooker according to claim 29 wherein the pressure vessel is also a vacuum vessel, wherein one or more of the wails of the pressure vessel are two-layered walls with a vacuum cavity between the two layers to insulate contents of the pressure vessel.

48. A pressure cooker according to claim 29 comprising a pumping line safety valve to exhaust content from a pumping line of the pump to a suction line of the pump to relieve pressure in the pumping line when the pressure inside the pumping line reaches a maximum pumping line safety pressure.
